(19) United States
(12) Patent Application Publication
(10) Pub. No.: US 2023/0140918 A1
(43) Pub. Date: May 11, 2023

(54) INTELLIGENT AUTOMATED COMPUTING SYSTEM INCIDENT MANAGEMENT

(71) Applicant: unSkript, Inc., Los Altos Hills, CA (US)

(72) Inventors: Abhishek SAXENA, Los Altos Hills, CA (US); Amit CHANDAK, Santa Clara, CA (US)

(21) Appl. No.: 17/981,993

(22) Filed: Nov. 7, 2022

Related U.S. Application Data
(60) Provisional application No. 63/277,589, filed on Nov. 9, 2021.

(51) Int. Cl. G06Q 10/06; G06N 20/00

(52) U.S. Cl. CPC G06Q 10/0633; G06N 20/00; G06Q 10/0635

(57) ABSTRACT

A system for automatic incident response is disclosed. The system is programmed to receive information regarding an incident (event). The system is programmed to apply an action prediction model for inferring one or more programming actions from key phrases in an incident report, or apply a workflow prediction model for inferring one or more workflows of actions from an event descriptor. In response to receiving user input to modify a current workflow, the system is programmed to apply a workflow step prediction model for generating a recommended workflow from the modified workflow. The system is programmed to then apply a risk model for computing a risk score from the recommended workflow and user or environment information. The system is programmed to then transmit an alert or a confirmation depending on whether the risk score exceeds a threshold.

### BENEFIT CLAIM

This application claims the benefit under 35 U.S.C. § 119 of U.S. Provisional Application 63/277,589, filed Nov. 9, 2021, the entire contents of which are hereby incorporated by reference for all purposes as if fully set forth herein.

### FIELD

The subject matter disclosed herein relates to maintaining computer system availability and functionality, and more specifically, to automating incident management and response for computer systems.

### BACKGROUND

Ensuring high computer system availability and functionality helps organizations to ensure that users, customers, and other entities that use and/or depend on the computer system can avail of the full feature set afforded by the system without performance degradation. The term “computer system” as used herein refers generally to the hardware, networking, software, services, and other elements that deliver functionality locally and/or remotely (e.g. over a network such as the Internet). When the computer system is cloud-based users may not be directly aware of the underlying hardware and may be exposed to the functionality provided by the system through various application programming interfaces (APIs), which may facilitate delivery of the functionality and user-interaction with the system.

Organizational teams that are responsible for ensuring functionality and availability often struggle with addressing downtime and incident service requests. Typically, a service ticket may be opened for each issue that is flagged by a user. “Runbooks” or “playbooks” (hereinafter “runbooks”), which may detail procedures that have been used to resolve similar issues, may then be used to handle the issue manually by one or more administrators, incident response specialists, and/or an on-call team. For example, runbooks may describe, in detail, a set of actions – termed a workflow – that may be taken to resolve specific incidents or service requests. However, manual incident response can be cumbersome, time-consuming, and error-prone. Thus, systems, methods, and tools to intelligently automate incident response can speed up response times, free up resources, decrease errors in repetitive workflows, and contribute to improved system functionality and higher availability.

### SUMMARY

Disclosed embodiments facilitate intelligent automated incident response determination and updating in a computer system, which may comprise a plurality of disparate subsystems. In some embodiments, the automated incident response workflows may be obtained using machine learning and other artificial intelligence (AI) techniques.

In some embodiments, a processor-implemented method to facilitate automatic incident response may comprise: receiving at least one event with an event descriptor, wherein the event descriptor includes an event identifier and an event description; predicting, based on at least one of the event identifier, or keyphrases in the event description, at least one of: one or more actions in a workflow to respond to the event; a workflow based on a corresponding input event descriptor; or a combination thereof. In some instances, the at least one event may be generated by one of agents running on a computing system, or an alert generation system, or a combination thereof. As one example, the at least one event may comprise an operational request and the incident response may occur in response to the operational request.

In some embodiments, the prediction of the one or more actions in the workflow may be performed by an action-prediction model. In some embodiments, the action-prediction model may be obtained using machine learning techniques based on input keyphrase and action pairs.

In some embodiments, the prediction of the workflow may be performed by a workflow-prediction model. In some embodiments, the workflow-prediction model may be obtained using machine learning techniques based on input workflows associated with prior events, wherein the prior events are associated with prior event descriptors.

In some embodiments, the one or more actions in the workflow to respond to the event may be associated with one or more corresponding action risk-scores, and the workflow is associated with a corresponding workflow risk-score. For example, the corresponding action risk score may be based on one or more of: a corresponding action type, or a corresponding action environment, or a corresponding user profile associated with a user executing the action, or a combination thereof.

Further, in some embodiments, the corresponding workflow risk score may be based on one or more of: parameters associated with the one or more actions comprised in the workflow, or the one or more corresponding action risk scores of the one or more actions comprised in the workflow, or a combination thereof. In some embodiments, a user may be alerted when the corresponding one or more action risk scores exceed an action risk threshold, or the corresponding workflow risk score exceeds a workflow risk threshold.

Disclosed embodiments also pertain to an apparatus comprising a memory, a network interface, and a processor coupled to the memory and the network interface wherein the processor is configured to perform the methods outlined above and other methods disclosed herein.

Some disclosed embodiments also pertain to a non-transitory computer-readable medium comprising instructions to configure a processor to execute the methods above and other methods disclosed herein.

In another aspect, a processor-implemented method to facilitate automatic incident response may comprise: determining based on one or more input sources associated with incident response events, one or more of one or more actions associated with at least one target environment and keyphrases associated with the actions; training at least one of: an action-prediction model using machine learning techniques based on input keyphrase and action pairs, wherein the action-prediction model is trained to predict an actions based on at least one corresponding input keyphrase; or a workflow-prediction model using machine learning techniques based on input workflows and event descriptors, wherein the workflow-prediction model is trained to predict a workflow based on a corresponding input event descriptor; or a combination thereof; and deploying at least one of the action-prediction model, or the workflow-prediction model in an interactive incident response environment. As one example, the at least one event may comprise an operational request and the incident response may occur in response to the operational request.

In some embodiments, the method may further comprise receiving an input event descriptor, the input event descriptor comprising an event identifier and one or more keyphrases describing the event; and predicting, based on the input event descriptor, at least one of a workflow to respond to the event, or one or more actions in a workflow being composed to respond to the event.

In some embodiments, the input sources may comprise one or more of: incident response audit trails, or application programming interface (API) documentation for the at least one target environment, or incident response runbooks, or incident response text documentation, or web based API sources, or logged workflows, or some combination thereof. In some embodiments, natural language processing may be applied to the input sources to determine keyphrases.

Disclosed embodiments also pertain to an apparatus comprising a memory, a network interface, and a processor coupled to the memory and the network interface wherein the processor is configured to perform the methods outlined above and other methods disclosed herein.

Some disclosed embodiments also pertain to a non-transitory computer-readable medium comprising instructions to configure a processor to execute the methods above and other methods disclosed herein.

The methods disclosed may be performed by one or more of computers and/or processors, including distributed computing and/or cloud-based systems. Embodiments disclosed also relate to software, firmware, and program instructions created, stored, accessed, read, or modified by processors using computer readable media or computer readable memory.

### BRIEF DESCRIPTION OF THE DRAWINGS

FIG. 1 shows an exemplary schematic illustrating some elements of a computer system 100 to facilitate automated computing system incident management.

FIGS. 2A, 2B, 2C, 2D, and 2E show flowcharts associated with a method related to an AI/ML model to facilitate automated computing system incident management.

FIG. 3 shows an example action prediction for a workflow in response to an event.

FIG. 4 shows a flowchart of a method to add workflows during the running of an automated computing system incident management system.

FIGS. 5A and 5B show flow diagrams illustrating process flow for a workflow prediction / recommendation system including risk score determination according to some disclosed embodiments.

FIGS. 6A and 6B show an example UI window illustrating options available to a user to configure, save, and/or run an example workflow.

FIG. 7 illustrates some operations available to user to configure actions / steps associated with workflows.

FIG. 8 shows an exemplary computer capable of facilitating automated computing system incident management accordance with some disclosed embodiments.

### DETAILED DESCRIPTION

Addressing production downtime and service requests can be a significant challenge for DevOps and Site Reliability Engineering (SRE) teams. The term “DevOps” refers to practices that facilitate rapid software development and deployment. DevOps teams aim to provide continuous software delivery while maintaining high software quality. SRE teams may use software to automate IT tasks, manage production and development systems, perform IT operations, and resolve problems. System downtime, errors, and/or other system malfunction – both hardware and software – can detrimentally impact availability and decrease user confidence. In addition, Service Level Agreements (SLAs) may often provide guarantees to users / customers regarding system availability and/or other system performance parameters. Thus, resolving issues that may arise quickly (in time), efficiently (in terms of resource use), correctly, and reliably (to prevent issue recurrence) can facilitate achievement and maintenance of delivery, quality, availability, performance, and other goals.

Organizational teams that are responsible for ensuring functionality and availability often struggle with addressing downtime and incident service requests. When a user or customer encounters an issue, the user may open a service ticket, which may include information about the problem being experienced. Typically, runbooks, which may detail procedures (termed “workflows”) that have been used to resolve similar issues to those outlined in the service ticket, may be used to address the issue manually by an incident response team. The term “incident response,” as used herein, refers to actions taken in response to incidents or events that may occur during system operation such as security incidents (e.g. security breaches, unauthorized / malicious actions, etc.) , performance incidents (e.g. sub-optimal performance relative to some predefined metrics), failures (software and/or hardware), bugs (e.g. errors affecting system operation), operational requests (e.g. adding, removing, updating, or changing users, program code, software, hardware, etc.), and/or any other actions that may be taken by users, administrators, or teams to address incidents.

A workflow may include or be viewed as a set of elemental steps or actions that are performed to address an issue. The term “elemental step” refers to actions taken at an appropriate level of functional granularity. Elemental steps may be specified at a level of granularity appropriate to the task being performed and may be defined by users and/or the IR team. An elemental step may thus be viewed (in the context of an IR system) as an atomic step that provides some functionality related to a component (application, service, subsystem, hardware, etc.) of system 100. In some instances, such as a cloud native context, the granularity of the elemental step may be at the level of an application programming interface (API) call, and/or a user-defined code snippet, and/or a script (e.g. shell script), and/or code block targeted to produce a specified result or output. As another example, in some instances, the workflow may be described in terms of the lowest level of functional granularity available to the IR team.

An elemental step may be described in terms of (a) an API call, and/or program code snippet and/or shell command, (b) input parameters schema (e.g. names, descriptions, types, etc.), (c) output parameters schema (e.g. names, descriptions, types, etc.), (d) credential / authentication information including credential type (e.g. whether for SQL, AWS, etc.). Thus, an elemental step may be included in a workflow with information including values for input parameters, output parameters (e.g. obtained upon execution), credentials (to execute elemental step in workflow), execution environment (e.g. environment type for remote execution), conditions for execution (e.g. conditional logic to specify conditions for invoking the elemental step).

If the issue identified in the service ticket is identical to a corresponding issue addressed by the runbook, then the runbook workflow may be used by the response team. However, in practice, service ticket issues will often differ from prior issues - so workflow modifications may occur. In addition, manual incident response can be cumbersome, time-consuming, and error-prone - because the workflow may not have documented the issue completely, or the current incident response team may misinterpret workflow actions that were documented by a different team, or because workflow steps may be omitted or incorrectly executed, or for various other reasons. Thus, while runbooks can be a good resource, they can often fail to capture and/or document available organizational knowledge. Accordingly, in the scenarios described above, the incident response team may request further assistance from subject matter experts (SMEs) to help resolve the issue after initial troubleshooting attempts (e.g. based on the runbook workflow). In such scenarios, once the on-call team troubleshoots the problem to lie within a specific expertise area, they involve the individuals subject matter experts (SME) to further troubleshoot the problem and establish a root cause or determine next steps. Documenting these steps accurately in workflows (e.g. for resolving similar issues later) can be challenging given the number of teams and personnel involved and consume additional resources.

Workflow tools that may attempt to capture and automate runbooks may encounter problems related to: (a) issue differences (a current issue is different from a prior issue that is being used as a model); or (b) changes to the environment (hardware and/or software), or other unanticipated conditions that make the prior workflow less effective; (c) outdated runbooks (e.g. workflow changes that were not documented rendering the runbook obsolete); (d) limited applicability because of inherent tool constraints (e.g. support for a limited or fixed set of actions and cases); (e) difficulty to modify tools to improve and/or extend capabilities (e.g. deep programming knowledge or substantial tool expertise) to add capabilities that are not supported natively; etc.

Thus, systems, methods, and tools to intelligently automate incident response can speed up response times, free up resources, decrease errors in repetitive workflows, and contribute to improved system functionality and higher availability.

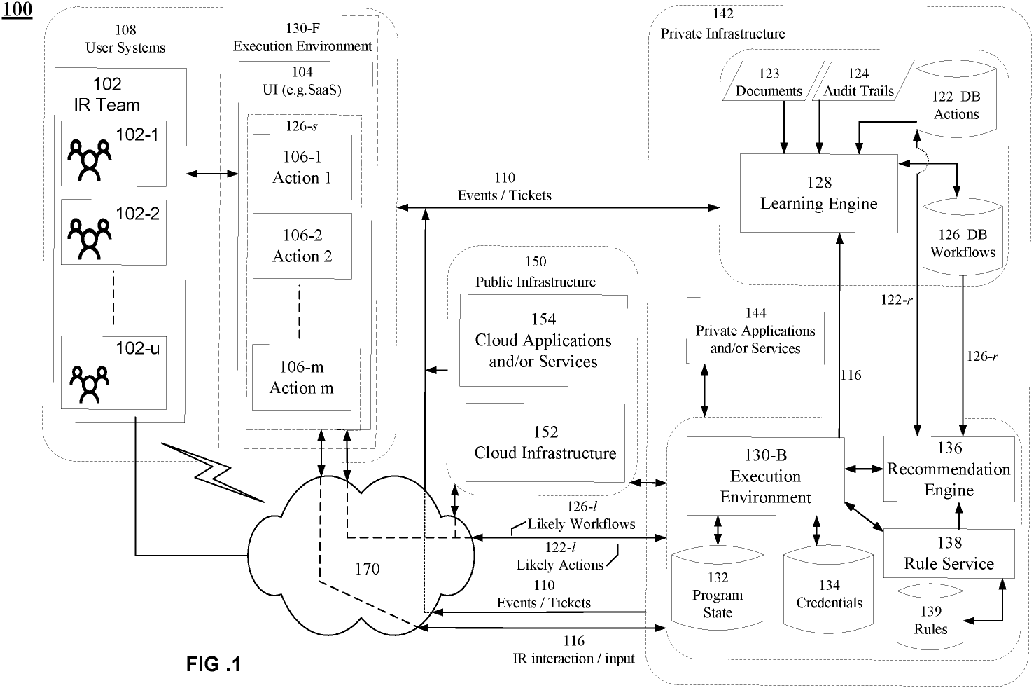

FIG. 1 shows an exemplary schematic illustrating some elements of a computer system 100 to facilitate automated computing system incident management. As shown in FIG. 1, system 100 may comprise some combination of a public infrastructure 150 (e.g. a publicly available cloud such as AWS, Azure, etc.), private infrastructure 142 (e.g. private clouds, private computing infrastructure, etc., which may be specific to an organization), and user systems 108 (e.g. used by IR team 102).

As shown in FIG. 1, the runtime environment for system 100 may include two subsystems. A front-end subsystem, which may be distributed, is shown as operating within execution environment 130-F provides a user interface 104 to facilitate user interaction with the system and to monitor, track, and respond to events / tickets 110. Events / tickets may be associated with system related issues and/or operational requests (e.g. adding a user to a system, updating software, etc.) A back-end subsystem, which may include execution environment 130-B, may accept input, commands, etc. from the front-end and provide input, recommendations, information, etc. to the front-end. The term “incident” includes events that may occur spontaneously or periodically on a system, user tickets related to an issue being experienced by one or users, and/or operational requests. In some embodiments, the front end and back end of system 100 may be separate entities and be configured to run in different environments. For example, the back end runtime environment, which includes execution environment 130-B, may be run at an organizational location (e.g. at the location of private infrastructure 142) as a cloud virtual machine, which facilitates organizational control over the execution environment (e.g. security, access policies, etc.) and also affords protection to authentication information, secret keys, etc. that workflows may utilize. The front end portion, which includes execution environment 130-F, may run the user interface and facilitates user interaction and input – including composition and/or modification of workflows – which, may be processed and/or executed by the back-end runtime environment.

Accordingly, in some embodiments, user systems 108, which may be used by Incident Response (IR) team 102, may be remotely situated from private infrastructure. Further, in some instances, user system 108 may comprise one or more geographically distributed systems. For example, one or more of users 102-1, 102-2 ... 102-u may use local systems (e.g. a local computer) that are situated remotely from some other users 102 and applications accessed and utilized by users 102 via User Interface (UI) 104 may take the form of Software as a Service (SaaS) application. UI 104 may form the user interface to an interactive programming environment, which may facilitate use of high-level languages to extend and modify existing workflows and add/create new workflows.

In some embodiments, local execution environment 130-F, which may be local to a user 102, may provide UI 104 to facilitate user interaction with system 100. For example, local execution environment 130-F may communicate with execution environment service 130-B running on private infrastructure 142. In some embodiments, execution environment service 130-B may facilitate user interaction with functional blocks and other elements on private infrastructure 142 and/or in public infrastructure 150. Public infrastructure may include cloud based application and/or services 154, which may run on cloud infrastructure 152. Public infrastructure 150 utilized by system 100 may be provided one or more cloud providers - such as AWS, Azure, Google Cloud, etc.

In some embodiments, one or more members of IR team 102 may receive (e.g. via UI 104 and/or local execution environment 130-F) one or more events and/or tickets 110 (hereinafter “events”). For example, IR team 102 may receive notifications about various events such as, application errors, service failures, security breaches, virtual machine (VM) failures, hardware failures, networking related errors, unusual activity, operational requests, and/or any other issue to be addressed by IR team 102. Events 110 may be monitored and reported automatically (e.g. by agents running on system 100) and/or may be reported (e.g. as a service ticket) by a user of system 100. For example, an agent running on public infrastructure 150 may log and report an event such as a failure, error, performance, or other issue to execution environment service 130-B, which may create (or initiate the creation of a service ticket or) event 110 with a description of the issue and forward the event to local execution environment 130-F over network 170 (including over the Internet) securely.

In addition, in some embodiments, execution environment service 130-B may also receive input from one or more of recommendation engine 136 and rule service 138 in response to event 110. In some embodiments, recommendation engine 136 may include an artificial intelligence (AI) and/or Machine Learning (ML) model, which may process event 110 and predict a recommended set of one or more likely workflows 126-r that may be used to address event 110. In some embodiments, risk scores associated with the actions, workflows, environments, and/or users may inform recommendations. Workflow database 126_DB may store workflows that have been previously used and/or are being currently created/used (e.g. by IR team 102) to address events 110 in system 100. Rule service 138 may use rules 139-r, which may be obtained from rules database 139 to determine conditional logic for execution of workflow 126 and/or some portion thereof.

In some embodiments, execution environment service 130-B may use rules 139-r and program state 132 to select a set of likely workflows 126-l from the set of recommended workflows 126-r that are both applicable (e.g. based on the current conditions) and likely (e.g. based on event 110). In some embodiments, a risk score may be determined for actions or workflows associated with event 110 and likely workflows may be ordered based on risk, or actions / workflows with greater risk may be flagged and/or approval requested (e.g. from a user or from an authorized supervisor). Risk scores may be considered or factored into action/workflow recommendations. Risk scores may be based on the type of action (e.g. whether an action is a read, write, read-write, or execute), and/or the environment in which the action is executing (e.g. test, development, runtime, etc.), and/or the user(s) (e.g. user-level, user-profile, user rank, length of employment, and/or other user-profile information, etc.). In some embodiments, likely workflows 126-l may be provided to local execution environment 130-F, which may populate display information pertaining to actions /elemental steps 106 associated with the workflow in UI 104.

IR team member 102 may use UI 104 to select one of likely workflows 126-l, and/or may further edit, and/or modify selected workflow 126-s. As shown in FIG. 1, workflow 126-s may include actions 106-1, 106-2 ... 106-m. IR team member 102 may edit/modify the workflow by changing conditionalities associated with actions, adding iterative operators to actions, deleting actions, adding new actions, etc. For example, after selection of workflow 126-s may delete action 106-2 and add action 102-k (not shown in FIG. 1). In some embodiments, IR team member 102 may opt to reject all of the likely workflows 126-l and create a new workflow using UI 104.

In some embodiments, UI 104 may also be used to query workflow database 126_DB and/or action database 122_DB (e.g. directly and/or using execution environment service 130-B) to obtain additional actions 122 and/or workflows 126 when creating and/or modifying a workflow. For example, IR interaction 116 of IR member 102 may be monitored and IR interaction 116 may be relayed to execution environment service 130-B, which may provide some or all of the information to recommendation engine 136. IR interaction 116 may include an updated workflow and/or list of actions 106 based on current user selections and/or modifications in UI 104. Accordingly, in some embodiments, based on current user selection and/or modification information (e.g. in IR interaction 116), execution environment service 130-B may recommend an updated likely workflow 126-l and/or suggest other actions 122-l based on input from recommendation engine 136 and/or rules service 138. For example, recommendation engine 136 may determine that actions 106-i and 106-j are often associated with action 106-2 and may recommend (i) actions 106-i and 106-j for inclusion in the workflow when action 106-2 is added by IR team member 102, and/or (ii) conditional logic typically associated with action 106-2, etc. Thus, system 100 (e.g. one or more of recommendation engine 136, execution environment 130-B, and/or rules service 138) may provide real time and/or interactive suggestions (actions, logic, workflows, etc.) based on IR team interaction / input 116. In some embodiments, IR team member 102 may select and include one or more actions (e.g. recommended actions 106-i and 106-j) into the workflow being composed.

In some embodiments, workflows 126 (along with actions 122 that form part of the workflow) that are composed and executed by the user may be obtained by execution environment service 130-B, which may use stored credentials 134 to run the workflow on one or more of private infrastructure (e.g. to address issues with private applications and/or services 144) public infrastructure 150 (e.g. to address issues with one or more cloud based services 154 and/or cloud infrastructure 152 for a specified cloud). Workflows may use stored credentials 134 to elevate privilege for execution. The credential store, which holds the credential 134, is a vault so that sensitive information is not exposed.

In some embodiments, execution environment service 130-B may also monitor workflow program state 132 and send periodic updates to IR team 102 using UI 104. In some embodiments, system 100 may provide functionality to facilitate dynamic (e.g. while a current executing workflow 126-c associated with an event 110 is executing) changes to the executing workflow 126-c. In instances where current workflow 126-c is changed dynamically, the newly edited workflow 126-n may be substituted for the previously executing workflow 126-c. In some embodiments, the changes may be made without interrupting any current tasks. System 100 may also provide IR team 102 functionality to monitor and abort executing workflows or portions of the workflow.

In some embodiments, system 100 may facilitate use of or duplication of the workflow on another environment (e.g. to preemptively address an issue). Each environment may be associated with a set of credentials specific to the infrastructure and/or application. For example, when two environments are compatible (e.g. similar and with matching credentials) then system 100 may facilitate copying workflow 126-c1 associated with environment 1 to form workflow 126-c2, which may be associated with an environment 2.

In some embodiments, schema and documentation (e.g. for a target cloud, application, etc.) may be analyzed to determine elemental steps and/or actions and associate a description, input parameters, output parameters, privilege requirements, etc. for the elemental step / action. The term “target,” is used refer to a system or system resources including services (e.g. cloud based services, applications, etc.), computing platforms (e.g. application containers, virtual machines, hosts, cloud infrastructure, etc.), and/or any other system entity that is being operated on by IT team 102. Actions database 122_DB may include the above information for each elemental action available to IR team 102. The documentation may be available from the cloud /application provider and may be downloaded from web resources provided by the cloud / application provider. Further, learning engine 128 may also include a natural language processing (NLP) component to process runbooks and determine actions from the runbooks and potential key-phrases that may be associated with the actions / elemental steps.

In some embodiments, learning engine 128 may use inputs from actions database 122_DB, documents 123 (e.g. API documentation, existing runbooks, application specifications, etc.), and audit trails 124 (e.g. prior logged incident response actions) during a training phase to create an AI/ML model capable of predicting actions based on key-phrases. For example, in some embodiments, when training is complete, recommendation engine 168 may include an AI/ML model, to predict an API name based on key-phrase strings (e.g. in a ticket or event descriptor).

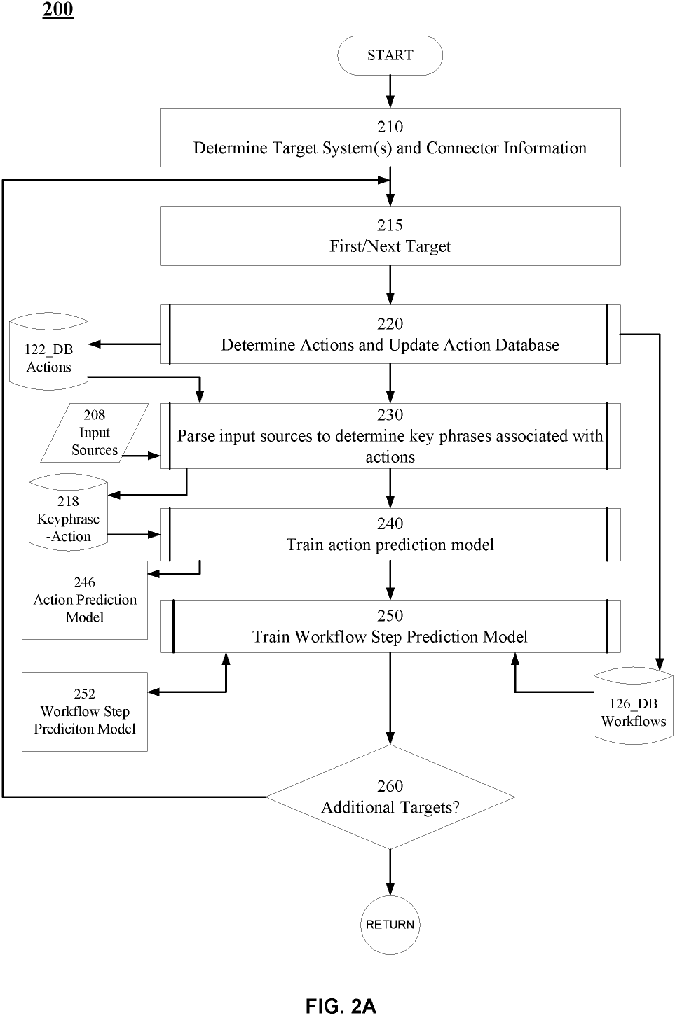

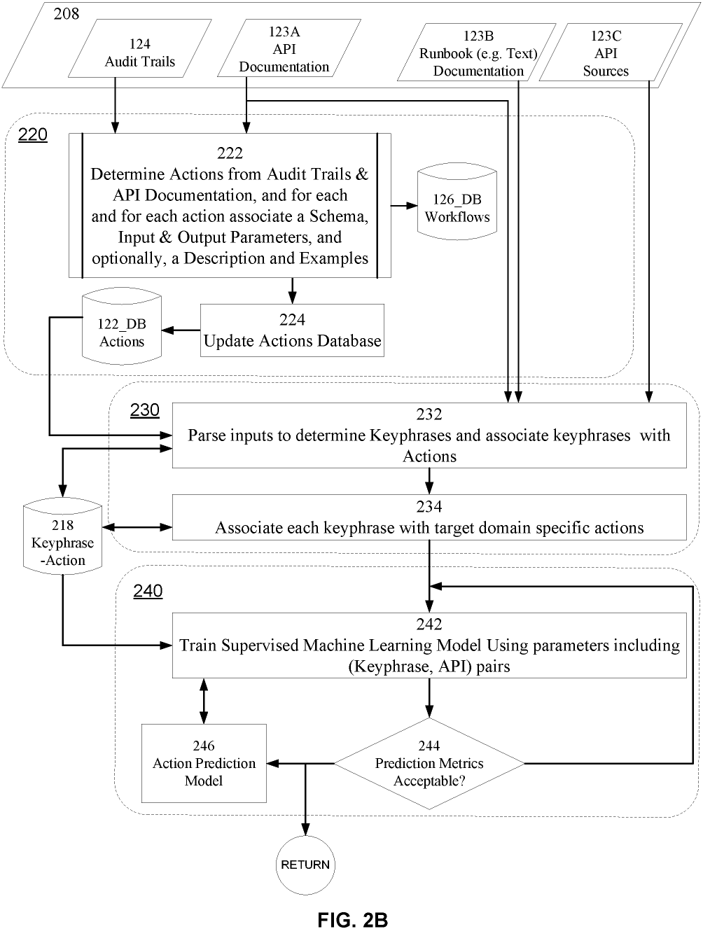

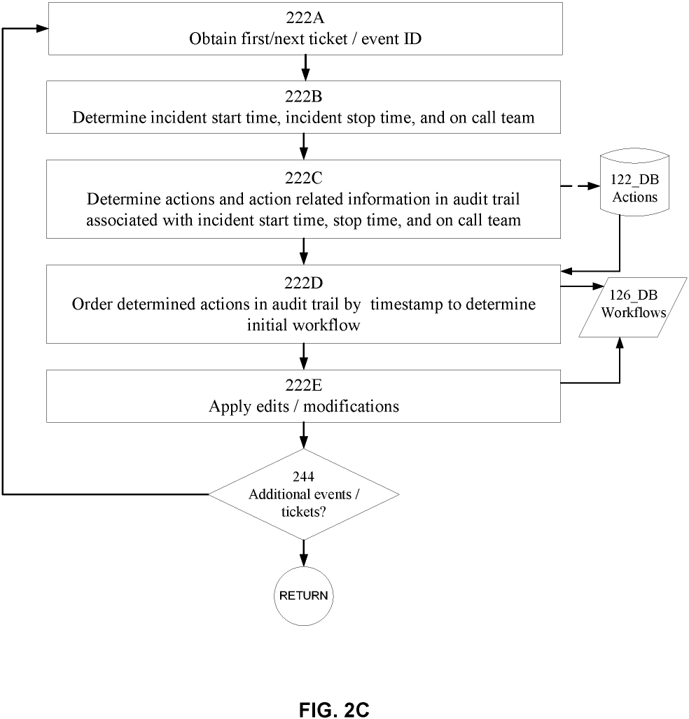

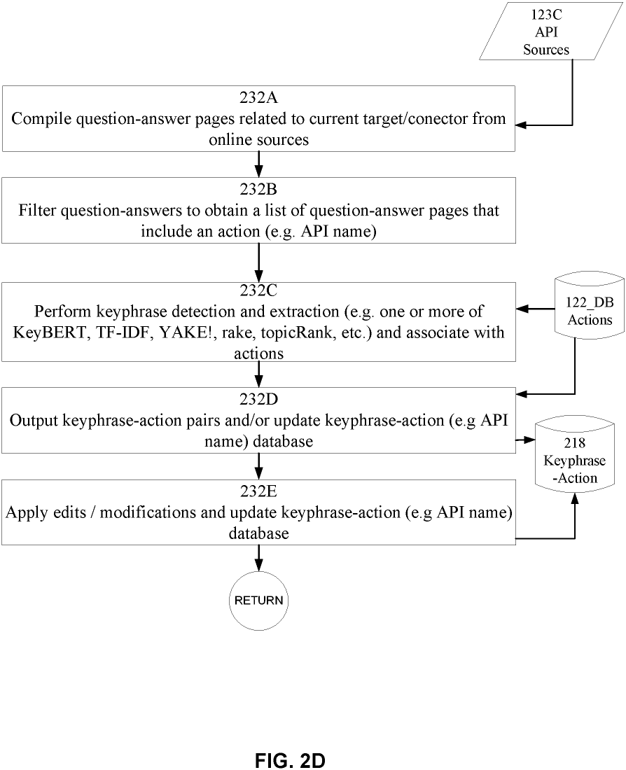

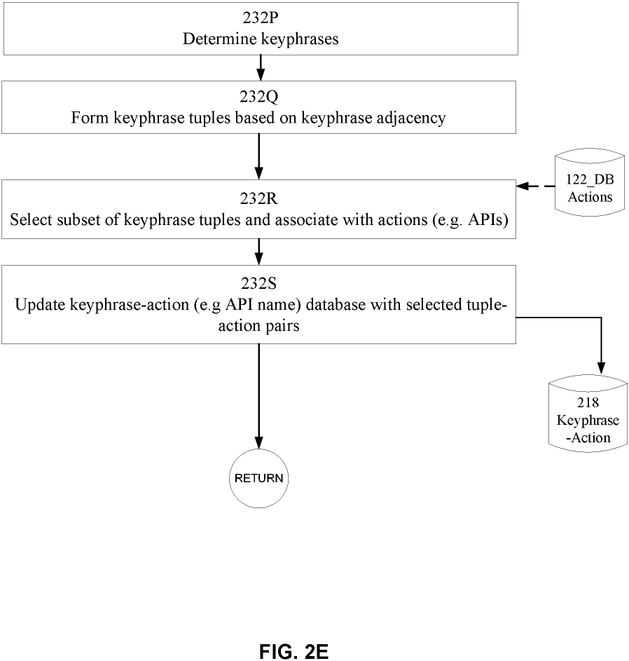

FIGS. 2A, 2B, 2C, 2D, and 2E show flowcharts associated with a method 200 for the creation of an AI/ML model to facilitate automated computing system incident management. In some embodiments, some or all of method 200 may be performed by a processor and/or learning engine 128. In some embodiments, portions of method 200 may be performed offline during a training phase.

In block 210, target systems and connector information may be determined. For example, targets may include cloud platforms such as AWS and agile software development applications such as Jira. In some embodiments, system 100 may be integrated with various target systems to facilitate seamless operation (e.g. by IR team 102 when responding to an event / service ticket). Each such target system may be internally modeled as a connector. The term “connector” is used to refer to credential and other information that may be used to access the target. For example, a connector definition may include credential requirements for accessing a target system. Connector information may be target specific and may be defined, in some instances, using connector schema that may be specific to a connector (e.g. on a per connector basis). For example, AWS connector schema may include “AWS_SECRET_ACCESS_KEY,” which may be defined as a String type and “AWS_ACCESS_KEY_ID,” which may also be defined as a String type. Similarly, for Jira, the Jira connector schema may include “Email,” which may be defined as a String type, and “API_TOKEN,” which may also be defined as a String type. As outlined previously, the actual authentication keys may be stored securely in a vault such as credential store 134.

In block 215, the first or next target may be processed and in block 220, elemental actions may be determined and action database 122_DB may be populated and/or updated with actions specific to the current target. In some embodiments, based on the action type and/or effect (e.g. whether the action results in reads, writes, and/or read-write), a risk score may be associated with the action in action database 122_DB. In some embodiments, block 220 may comprise blocks 222, and 224 (FIG. 2B).

Referring to FIG. 2B, in block 222, a list of elemental actions may be determined based on API documentation 123A and audit trails 124. For cloud native services, APIs are well documented and may be published and/or otherwise made available by service providers. Thus, API documentation 123A may be available online, or available as an electronic document, or in some other electronic form. API documentation 123A may include API names, API input parameters, API output parameters, privilege specification, and other optional information such as an API description/function, examples, etc. Accordingly, in block 222, API documentation 123A may be processed to determine actions from API documentation 123A. In some embodiments, Natural Language Processing (NLP) may be used to process API documentation 123A to determine elemental actions. In instances, where the API documentation is structured, the document may be parsed to determine elemental actions. In some embodiments, action effect and/or action type may also be determined using NLP (e.g. based on the presence of keywords).

Further, in some embodiments, in block 222, audit trails may be used to determine elemental actions associated with the current target. For example, if the current target is a public cloud associated with public infrastructure 150, then, audit trail 124 that captures all of the cloud API calls that were made (and satisfy some conditions such as being made during some time period) may be obtained along with information about the input parameters, user information, timestamps and results of the calls. As one example, AWS provides a “CloudTrail,” feature, which facilitates obtaining an audit trail. In some embodiments, audit trails 124 associated with events may be queried with conditions based on parameters such as ticket / event IDs 110, timestamps, time period, users, API results, etc. Accordingly, in block 222, cloud related steps captured in the audit trails 124 may be determined (e.g. based on tickets / events IDs 110 and/or time periods associated with one or more incidents). For example, information associated with an event may be used automatically generate a query (e.g. time period over which the event occurred and was resolved, etc.) and method 200 may further accept user input and/or other filters (e.g. via UI 104, and/or from a file, etc.), which may be applied to queries to obtain audit trails and determine a set of actions from the audit trail. Because audit trails record at the level of atomic API calls and API calls are atomic, elemental actions can be based on these atomic API calls. Thus, each API call entry in the audit trail can correspond to an elemental action. As outlined above, in some embodiments, a risk score may be determined and associated with the actions (e.g. API entries) in action database 122_DB. The risk score for actions 122 may be determined based on information/documentation about the actions 122 (e.g. whether the action results in reads, writes, and/or read-write etc.) and/or using a risk model, which may determine initial risk scores for actions 122 based on the actions that make up the workflow.

In some embodiments, in addition to determining actions from the audit trail, block 222 may also output workflow 126 associated with each event. For example, timestamps, user-ids (e.g. associated with users in IR team 102), event/ticket IDs, etc. may be used to determine steps associated with tickets / events 110 to determine a workflow 126. As one example, the actions may be ordered based on timestamp to determine workflow 126. In some embodiments, method 200 may further accept user input (e.g. via UI 104, etc.) such as conditional logic, iterative operators (e.g. to apply to one or more actions), etc., to edit and/or modify an initial automatically determined workflow and obtain workflow 126.

The process described above is illustrated in FIG. 2C, which illustrates a portion of block 222. In block 222A, a first or next identifier associated with ticket / incident 110 is obtained (e.g. from a store / database that logs and tracks tickets / events 110). In block 222B, (a) an incident start time, (b) an incident stop time, and (c) user IDs associated with an on-call IR team 102 that are associated with ticket / incident 110 may be determined. In block 222C, actions and action related information (e.g. API calls, call timestamp, result of call, etc.) in the audit trail for the incident start time, stop time, and on call team may be determined. In some embodiments, actions database 122_DB may be updated. For example, the action names and related action information may be provided to update actions database block 226 (FIG. 2B) to update actions database 122_DB. In block 222D, actions in audit trail may be ordered or sorted by timestamp to determine initial workflow 226-i. In block 222E, modifications and/or edits to initial workflow 226-i may be applied based on user input (e.g. conditional logic and/or iterative operators may be added to one or more actions) to obtain final workflow 126-ƒ, which is stored in workflow database 126_DB.

The pseudocode below provides an example of the method in FIG. 2C.

startTime // incident start time - scalar //
stopTime // incident stop time - scalar//
t //on call team - e.g. list of user IDs - list)
Process_audit_trail
{workflowltems = empty list // { } //
For p = all items in list t
Determine actions in audit trail performed by
(user = p) and (timeStamp > startTime) and (timeStamp < stopTime)
Append matching audit trail items to workflowltems
end
S = Sort workflowltems by time
}Return S

The returned list S in the pseudocode above is an ordered set that can be used to create an initial workflow 126.

In some embodiments, a risk score may also be determined for workflows 126. The risk score for actions 122 and/or the initial risk score for workflows 126 may be determined based on information/documentation about actions 122 that are comprised in workflow 126 and/or using a risk model, which may determine initial risk scores for workflow 126. For example, an initial or first risk score for workflow 126 may be based on the risk scores of actions 122 in workflow 126. The initial risk score for a workflow 126 may be modified to obtain a final risk score based on other considerations (e.g. environment, users, etc.) at / or near run-time, when information about other parameters is available. In some embodiments, the risk scores may be used to order recommendations, alert administrators, obtain user confirmation and/or approval prior to running the workflow. For example, when the risk score for an action 122 exceeds some action risk threshold (e.g. actions deemed risky) and/or the risk score for a workflow 126 exceeds some workflow risk threshold (e.g. workflow deemed risky), then additional approval / confirmation may be sought prior to running the workflow. While workflow risk scores and action risk scores may be related in some instances -the workflow risk score may exceed a workflow risk threshold even when the risk score for each action 122 in the workflow 126 is below the action risk threshold. For example, other factors such as the environment in which workflow 126 and/or the user(s) 102 running the workflow, etc. and/or other parameters that are determined to contribute to risk may affect workflow risk score. As outlined above, a risk model may determine a second or final risk score at / or near run-time.

In block 224, in some embodiments, unique actions may be stored in actions database 122_DB along with a Schema, Input and Output Parameters, and optionally, a Description and Examples. In some embodiments, when a record for an action is already present in actions database, missing fields (if any) may be updated.

Referring to FIG. 2A, in block 230, various other available input sources may be parsed too determine keyphrases to associate with actions. Keyphrases may be keywords or a sequence of words, symbols, characters, etc. that are likely to indicate or be associated with at least one action. For example, the keyphrase “start virtual machine,” or “start EC2 instance” in a document may be associated with a “launch AWS instance,” action when the target is public AWS cloud. Keyphrase detection and extraction may be performed using various methods such as KeyBERT, TF-IDF, YAKE!, rake, and topicRank. The keyphrase-action pairs may be stored in keyphrase-action database 218. In some embodiments, block 230 may comprise blocks 232 and 234 (FIG. 2B).

Referring to FIG. 2B, in block 232, input sources may be parsed to determine keyphrases that are associated with action. Input sources may be runbook documentation or other types of text documentation 123B (hereinafter “runbook documentation”). As outlined above, keyphrase detection and extraction may be performed using various methods such as KeyBERT, TF-IDF, YAKE!, rake, and topicRank and stored in keyphrase-action database 218. In some embodiments, input sources may be knowledge bases, which may document user steps that were (or are to be) executed including details of the actual commands used (or to be used) in response to an incident. Given such knowledge bases (e.g. which may comprise document sets), actions / API names being used may be extracted along with keyphrases associated with the actions / API names to obtain action-keyphrase pairs.

As one example, referring to FIG. 2D, keyphrases may be descriptions of APIs, occur in the context of an API in runbook or other text documentation, or occur in API sources 123C. API sources 123C may be online / web based. In some embodiments, in block 232A, a set of answered questions may be obtained from API sources 123C. For example, the set of answered questions may be compiled from online / web sources such as social and/or collaborative websites for the current connector (e.g. AWS). In block 232B, the set of questions and answers may be filtered to obtain a list of question-answer pairs that include an action (e.g. API) name.

In block 232C, keyphrase detection and extraction may be performed on the filtered list and associated with actions (e.g. APIs) in each question-answer pair. In some embodiments, in block 232D, the keyphrase-action pairs may be presented to a user and upon approval, may be used to update keyphrase-action database 218. In some embodiments, a user may edit, modify (e.g. edit the keyphrase or make other changes, or reject one or more of the keyphrase-action pairs. In block 232E, user edits and modifications may be applied to the keyphrase-action pairs and approved keyphrase-action pairs may be used to update keyphrase-action database 218.

Referring to FIG. 2E, in instances where the input sources comprise runbook documentation 123B, in block 232P, runbook documentation 123B may be parsed to determine keyphrases. Runbooks may be text documents with or without a specified document structure. If the runbook documentation 123B is structured (e.g. with various defined or standardized fields) then the structure may be exploited and specific portions of the runbook may be used to detect and extract keyphrases (as outlined above) and associate keyphrases with actions based on: (a) document structure, and/or (b) proximity of listed actions (e.g. APIs) to detected keyphrases. If runbook documentation is a text document without a defined structure, then, in block 232P, one of the methods outlined above or a text search algorithm may be used to detect likely keywords or keyphrases and associate keyphrases with actions that may be listed in proximity to the keyphrases.

In some embodiments, in block 232Q, when keyphrases are textually adjacent to each other, then one or more tuples each comprising two or more keyphrases may be constructed. For example, if a sentence includes keyphrases kp1, kp2, kp3 ... kpN-1, kpN, tuples created may take the form (kp1, kp2), (kp2, kp3)... (kpN-1, kpN).

In block 232R, a subset of the keyphrase tuples may be selected. In some embodiments, user input may be used to facilitate selection of pertinent keyphrases and associate keyphrase tuples with to actions / API names. In some embodiments, association of keyphrase tuples with to actions / API names may be based on the textual proximity of actions / APIs relative to the keyphrase tuples. In situations, where keyphrase tuples map to multiple actions and/or APIs, user input may be solicited. For example, an ordered or ranked list of tuples may be presented along with associated actions to facilitate selection and association of keyphrase tuples with actions / APIs.

In block 232S, the selected keyphrase tuple-action pairs may be used to update keyphrase action database 218.

Referring to FIG. 2B, in block 234, keyphrases may further be associated with target domain specific actions. For example, a keyphrase may signify one action in the context of a first target domain (since actions may be target domain specific) and a different action in the context of a second target domain. In block 234, keyphrases may be grouped with other keyphrases and/or actions across domains based on domain knowledge. For example, the keyphrase “virtual machine” may be associated with “EC2 instance” or “instance” for the AWS target domain and with the action “launch AWS instance”. As another example, the keyphrase “firewall” may be associated with “security group” for the AWS target domain. Keyphrases along with domain specific actions and grouped keyphrases may be stored in keyphrase-action database 218.

Referring to FIG. 2A, in block 240, (“keyphrase”, “action”) and/or (“keyphrase”, “API”) pairs along with other pertinent information are input into a supervised AI/ML model, which when trained results in Action Prediction model 246, which may predict actions based on an input keyphrase, which may occur in the context of a description of service ticket / event 110. In some embodiments, block 240 may comprise blocks 242 and 244 (FIG. 2B).

Referring to FIG. 2B, in block 242, a Supervised AI/ML model may be trained using parameters, which may include (Keyphrase, Action) pairs or (Keyphrase, API) pairs. For example, during the supervised learning phase, the keyphrase-action / keyphrase-API pairs may be used by program code to predict actions accurately based on an input keyphrase. Various methods such as linear classifiers, support vector machines (SVM), decision trees, k-nearest neighbor, and random forest, and/or variations thereof may be used in block 242 during the training phase.

As training data is input, the program code may make adjustments to internal weights and other parameters until the action prediction metrics are met. In block 244, if the prediction metrics are acceptable (errors within an acceptable range), then action-prediction model 246 may be marked as ready for deployment and execution. In some embodiments, the trained action-prediction model 246 may form part of recommendation engine 136.

In block 250, a workflow step prediction model may be trained using existing workflows in workflow database 126_DB. As outlined previously, workflows 126 may be viewed as an ordered list of elemental actions. In some embodiments, parameters including workflows 126 may be input to workflow step prediction model 252 during a training phase. Workflow step prediction model 252 may be based, for example, on a Recurrent Neural Network (RNN), may be used to learn relationships between steps in workflows (across workflows) including an order or sequence between steps in workflows. For example, workflow step prediction model 252 may learn contiguity relationships between steps. Workflow step prediction model 252 may be trained over all the workflows that are created within the system. In addition, workflow step prediction model 252 may also continue learning online (e.g. while the system is running) as new workflows are added to the system and other modifications are made to workflows. In some embodiments, the trained workflow step prediction model 252 may form part of recommendation engine 136.

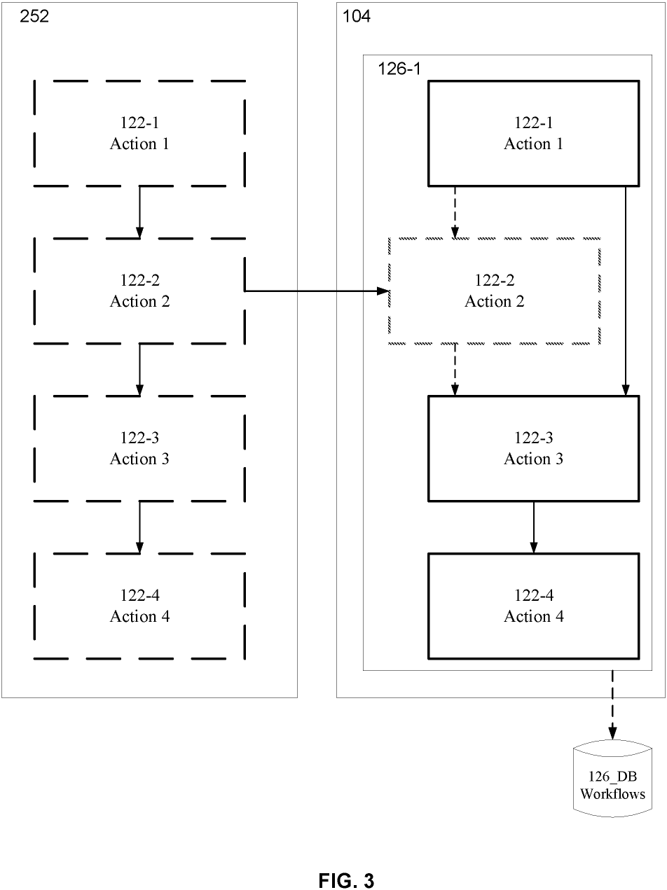

As shown in FIG. 3, during runtime, a user 102 may be in the process of composing workflow 126-1, which may currently include Action 1 122-1, Action 3 122-3, and Action 4 122-4. User actions in GUI 104 may be monitored and input to workflow step prediction model 252 (which may be part of recommendation engine 136). As shown in FIG. 3, workflow step prediction model 252 may then provide the user (e.g. via recommendation engine 136) with a recommendation for Action 2 122-2 to be added after Action 1 122-1 and before Action 3 122-3 based on prior learning. For example, as shown in FIG. 3, trained workflow step prediction model 252 may indicate that Action 2 122-2 follows Action 122-1 and precedes Action 3 122-3. The user may then accept or reject the recommendation. In some embodiments, an initial risk score may also be provided for workflows 126-1 and the updated / predicted workflow from workflow step prediction model 252.

When the workflow 126-1 is finalized, the finalized workflow 126-1, which may comprise Action 1 122-1, Action 2 122-2, Action 3 122-3, and Action 4 122-4 (if user 102 accepts the recommendation), may be added to workflows database 126_DB. As outlined previously, workflow step prediction model 252 may continue online learning as users accept, modify, and/or reject recommendations and additions and changes are made to workflows database 126_DB.

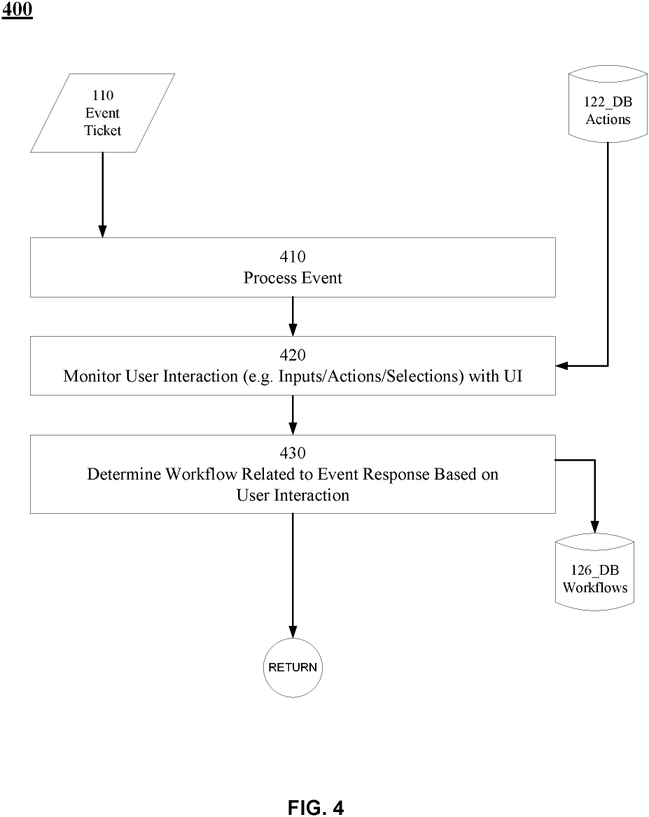

FIG. 4 shows a flowchart of a method 400 to add workflows during the running of system 100. In some embodiments, method 400 may be performed by execution environment 130 (e.g. execution environment 130-B and/or execution environment 130-F). As shown in FIG. 4, in block 410, event ticket 110 may be processed and execution environment 130 may provide recommendations for workflows 126 and/or actions 122 to user 102 in UI 104 as described herein. For example, keyphrases in the event description of event / ticket 110 may be used to recommend actions, and/or workflows to user 102.

In block 420, user interaction with UI 102 may be monitored. For example, execution environment 130-B may monitor user interaction with UI 102 and report user interaction related events (such as selections, rejections, edits, modifications, etc.) to execution environment 130-F, which may forward relevant events to recommendation engine 136. In some embodiments, recommendation engine 136 may dynamically provide alternate or new recommendations based on the input. For example, adding an action 122-k to a workflow may cause the recommendation engine to suggest the addition of an action 122-m (not currently part of workflow 126 being composed) or the deletion of action 122-n (which may be part of current workflow 126 being composed). In some embodiments, risk scores for workflows may be updated in interactively and/or in real-time as the user composes and/or edits the workflow.

In block 430, upon workflow finalization (e.g. when a workflow 126 is finalized and submitted for execution), execution environment 130-F may record the finalized workflow 126 and provide the finalized workflow 126 to recommendation engine 136, which may add the workflow to workflow database 126_DB and to workflow step prediction model 252 (e.g. for online learning). Thus, workflow step prediction model 252 may be viewed as an online self-improving workflow step prediction model that uses runtime inputs to fine tune internal model parameters.

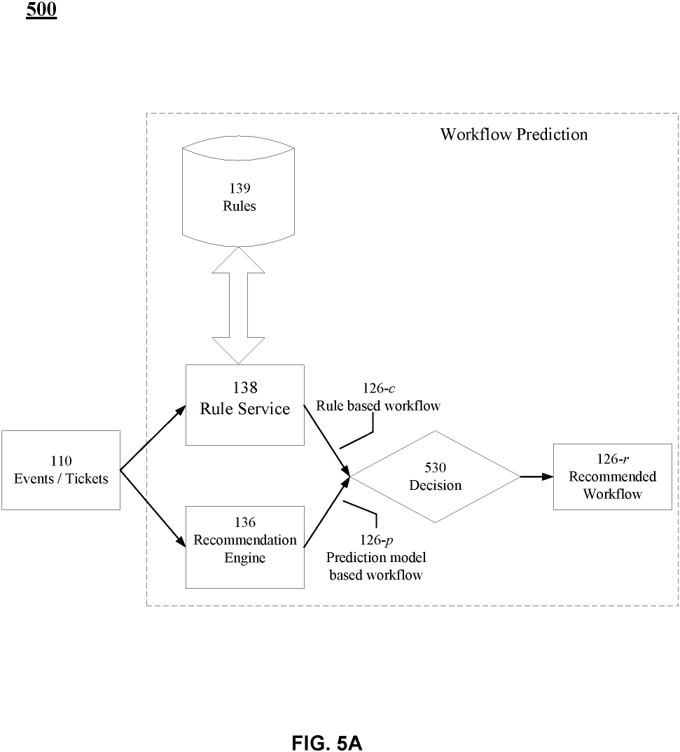

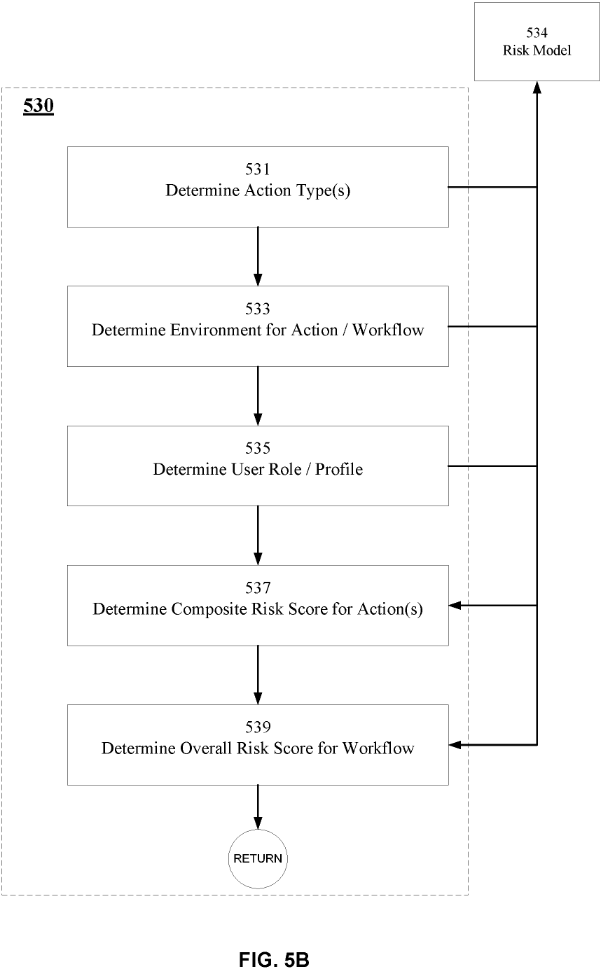

FIG. 5A shows a flow diagram illustrating process flow 500 for a workflow recommendation system according to some disclosed embodiments. In some embodiments, an action and/or workflow recommendation system may include recommendation engine 136, rule service 138, and decision engine 510.

In some embodiments, process 500 may be triggered when events /tickets 110 are received. Events 110 may be reported by software agents or hardware that monitors and reports events related to system 100 (FIG. 1) or a subsystem, component, service, or application associated with system 100. Tickets 110 may generated by users, customers, administrators, etc. As another example, process 500 may also ingest events 110 from external sources, which may be alert generation systems such as PagerDuty, DataDog, etc.

When a current ticket / event 110-c is received, a recommended workflow 126-r may be determined and recommended for execution by the system.

In some embodiments, rule service 138 may include a rule interface, which facilitates rule writing by users 102 related to tickets / events 110 and associates the rule(s) with a corresponding workflow 126-i. Rules may specify how information in tickets / events 110 may be translated into workflow related parameters. Rule service 138 may use rules in rule database 139 to output rule-based workflow 126-c in response to a corresponding current event 110-c (e.g. an alert from the alert generation system).

Rules may also be learnt by recommendation engine 136, which may include a learning component. For example, prior workflow selections (e.g. by user 102) associated with prior events 110-s (e.g. from an alert generation system) may be used to learn patterns between prior events 110-s (from the alert generation system) and the corresponding prior selected workflows 126-s (e.g. by users 102).

Learning may occur using a supervised learning model whose training inputs may include, the prior events 110-s (e.g. from alerting system), and the corresponding workflow IDs 126-s (e.g. that were selected/run by user 102). In some embodiments, for learning, when a workflow 126-s is/was selected and run manually, a workflow annotation is/was created that captures the corresponding event 110-s (e.g. from the alerting system) that triggered the running of workflow 126-s. Based on the model generated by learning (e.g. from prior input event triggers 110-s and corresponding prior workflows 126-s), recommendation engine 136 may include a workflow prediction model that predicts workflows 126-p corresponding to a current event 110-c (e.g. an alert from the alerting system).

Decision engine 530 may, in response to a current event 110-c, select between rule based workflow 126-c (e.g. from rules service 138) and prediction model based workflow 126-p (e.g. from recommendation engine 136). In some embodiments, when both rules service 138 and recommendation engine 136 provide a workflow, decision engine may be configured to prioritize or select rule based workflow 126-c.

In some embodiments, decision engine block 530 may determine risk scores associated with workflows 126-c and/or 126-p and provide risk scores to the user and/or take other actions in response to the risk score. In some embodiments, selection of a workflow (e.g. 126-c or 126-p) may be based, in part, on risk scores associated with the respective workflow.

FIG. 5B shows a flow diagram illustrating a method 530 for determination of a risk score for a workflow. In some embodiments method 530 may form part of decision engine block 530. In some embodiments, method 530 may be implemented as a distinct block, which may be invoked by another functional block (e.g. decision engine block 530) to determine risk scores associated with actions 122 and/or workflows 126 at or near run time.

In block 531, an action type may be determined for an action 122, which may be associated with workflow 126 (e.g. 126-c and/or 126-p in FIG. 5A). Action type may include information about the nature of the action such as whether the action performs reads, or writes, or read-write. Action types may further include information about whether action 122 updates, deletes, or otherwise changes information in system 100. The information and other parameters related to action type, which may be stored in action database 122_DB, may be provided to Risk Model 534. In some embodiments, risk model 534 may associate actions 122 with higher risk scores when actions 122 perform writes, updates, or deletes and lower risk scores when they perform only reads.

In block 533, an environment in which action 122 or workflow 126 is to operate may be determined and provided to risk model 534. For example, a user selection of an environment for an action 122 or workflow 126 may be input to risk model 534. Environments may include development, test, development-test, quality assurance (QA), staging, production, live, etc. Risk model 534 may deem actions 122 and/or workflows 126 operating in a production and/or live environment as higher risk relative to a test environment. Risk scores may further depend on the sensitivity of the information that is being accessed, updated, or deleted. For example, access (reads) or updates to a sensitive database may be deemed to be of higher risk score relative to a database that contains less sensitive information.

In block 535, a user-role and/or other user-profile information associated with a user executing action 122 or workflow 126 may be determined and provided to risk model 534. User roles may be tester, developer, administrator, deployment, QA, etc. In addition, user-profile information may include information about the user’s experience and/or the length of employment, etc. Risk model 534 may use user- role and/or user-profile information in determining risk scores for a workflow.

In block 537, for an action 122, a composite risk score may be determined (e.g. by risk model 534) based on inputs to risk model 534 (e.g. action type, environment, user role of user execution action, etc.). In some embodiments, the determination of the composite risk score may occur at or near the time of execution of the action.

In block 539, for a workflow 126 (which may be comprised of one or more actions), an overall risk score may be determined by risk model 534. In some embodiments, the overall risk score for workflow 126 may be a function of actions 122 comprised in the workflow 126 and/or composite risk scores of actions 122 in workflow 126, or a combination of one or more of the above factors. Control may then return to the calling routine (e.g. decision engine block 530).

In some embodiments, recommended workflow 126-r may include corresponding overall risk-score, which may be indicated to the user (e.g. in UI 104 (FIG. 1)). When the overall risk score for recommended workflow 126-r exceeds some workflow risk threshold, then execution environment 130 may request confirmation, approval, and/or send an alert to an administrator or other authorized personnel. In some embodiments, execution may be suspended until confirmation or approval is received.

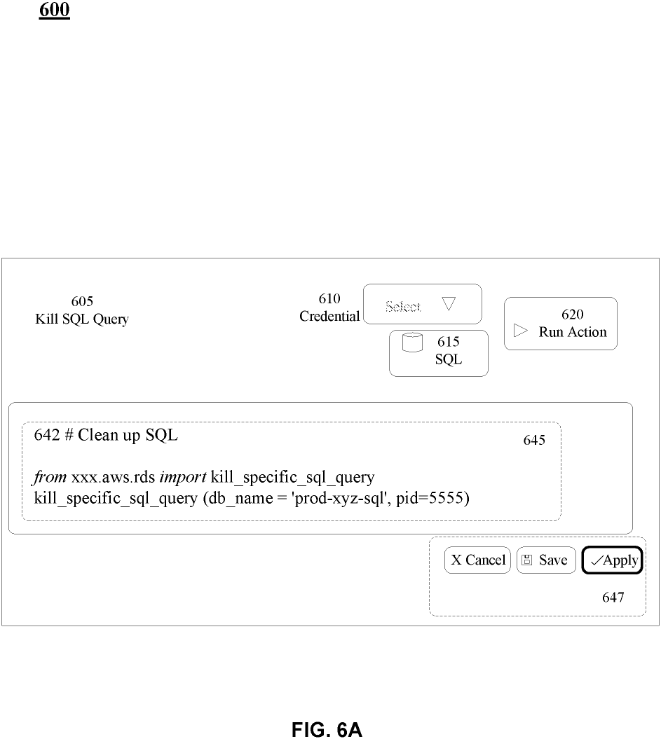

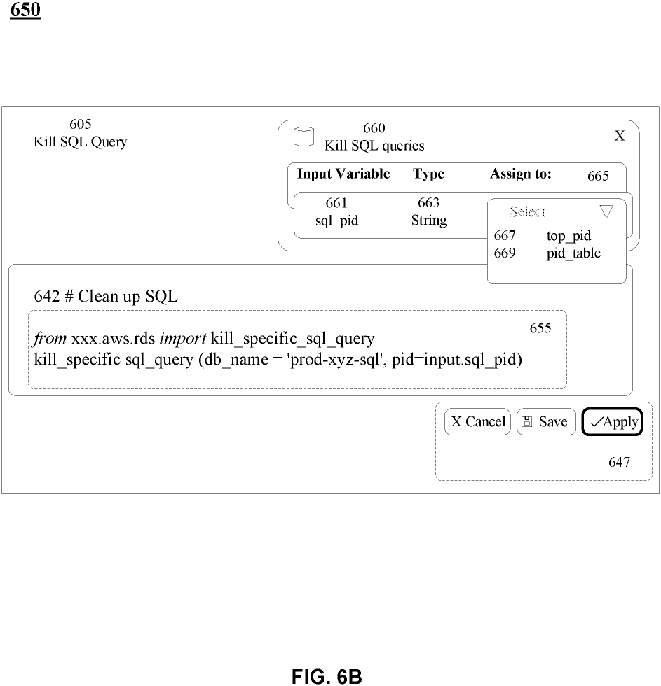

FIGS. 6A and 6B show an example UI window 600 illustrating options available to a user 102 to configure, save, and/or run an example workflow. As shown in FIG. 6A, the workflow may involve AWS, (a public cloud), which may be a target environment for one or more actions in the workflow. In some embodiments, UI window 600 may appear to user 102 as part of UI 104 within execution environment 130-F. As shown in FIG. 6A, the workflow in UI window 600 pertains to: (a) the importation of the specified action (e.g.“kill_specific_sql_query”) from AWS (target), and (b) the killing (termination) of a specific SQL query, where the action corresponds to “kill _specific _sql_query”.

In some embodiments, upon selection of the target /connector (e.g. AWS /SQL) and a keyphrase (e.g. “Clean SQL” or “Kill SQL” etc.), user 102 may be presented with UI 600 including options (e.g. by recommendation engine 136) to select and/or configure the workflow (e.g. credential selection 610 and/or actions shown in code snippet 645, etc.). For example, keyphrase 642 “Clean Up SQL” – a comment in code snippet 645 or workflow title/ID “Kill SQL query” 605 – may have been detected during parsing used to associate the workflow with the actions shown within code snippet 645 to facilitate recommendations.

As shown in FIG. 6A, the workflow may be identified by workflow title / ID 605 shown as “Kill SQL Query” and Credential selection widget 610 shows selection 615 SQL. Code snippet 645, which indicates actions to be performed during workflow execution, indicates that the action “import kill_sql_query” is to be performed and that the target is “xxx.aws.rds”, which may be a URL associated with AWS to obtain the action “kill_sql_query”.

In some embodiments, UI 600 may be used to specify the workflow input as a tuple (name, description, type, value ...), which may be made available to all actions /elemental steps in the workflow during execution. As one example, the value of workflow input parameters may be loaded into program memory as global variables. In some embodiments, one or more input parameters may be marked as “read only” to preserve values and prevent inadvertent changes by other program code. As an example, for a database, the input tuple may take the form, “Name: 'DB_Name', Type:String”, “Description: ‘Name of DB to run query on”’, Type: string” ... As shown in FIG. 6A, user 102 may then use UI 600 to provide an appropriate set of input parameter values such as the database name (shown as db_name = ‘prod_xyz-sql’ and, for the workflow shown, a process id of the process to be terminated shown as “pid = 5555”) to be used by the workflow.

Further, as shown in FIG. 6A, for each elemental step, the credential to be used may be selected by user 102 using credential selection widget 610, which may populate the selection menu based on named credentials present in the system. For example, credential selection widget 610 may filter named credentials by the connector type to present a list that shows credentials that the step can use for the connector type. In some embodiments, associations of credential names with the action / elemental step may be stored as the metadata for the action/ elemental step in the workflow. The workflow may be saved and/or changes applied using menu 647 and/or run using widget 620.

FIG. 6B shows an example UI window 650 illustrating some additional options available to a user 102 to configure, save, and/or run an example workflow.

User 102 may make changes to editable code snippets. For example, as shown in FIG. 6B, user 102 may appropriate changes to the code snippet 645 (shown in FIG. 6A) to specify inputs based on an input schema. For example, as shown in FIG. 6B, in some embodiments, UI 600 may use an input widget 660 that may be based on the input schema 665 of the action/step. FIG. 6B shows a portion of input schema 665 with “Input Variable” specified as “sql_pid” 661 (e.g. SQL process id) of “Type” “string” 663. The “Assign to” parameter 665 in input widget 660 specifies that the variable value may be obtained from either “top_pid” 667 or “pid_table” 669 (based on user selection). Further, code snippet 655 now shows that “pid=input.sql.pid”, indicating that the pid is to be obtained from the assignment (e.g. one of “top_pid” 667 or “pid_table” 669 in FIG. 6B) of “sql_pid” variable 661 in input widget 660. Thus, in some embodiments, input widget 660 may facilitate user input to specify values of various input parameters.

Input parameters may be specified based on: (a) a variable that was specified earlier in the workflow (e.g. “sql_pid” variable 661 in FIG. 6B), (b) a constant (e.g. “5555” for “pid” - the process id) in FIG. 6A, (c) output of some previous step, or some combination of the above. In some embodiments, variables and other assignments associated with an action /elemental step may be stored as action /elemental step metadata in the workflow.

In some embodiments, each action / elemental step (or groups of actions /elemental steps) may be run conditionally. In some embodiments, a logic widget (not shown in FIGS. 6A or 6B) may be provided for each step, which may accept, for example, a Boolean expression, to be evaluated prior to execution of the action / step (or group of actions / steps). The Boolean expression may be associated with the action / step (or group of actions / steps) and evaluate to determine whether the action / step (or group of actions / steps) is to be executed. When a group of actions / steps is specified, the Boolean expression may be evaluated when the first action /step in the group of actions / steps is to be executed.

In some embodiments, one or more actions / steps in a workflow may be labeled with an action or elemental step label. Labels may be used to run a subset of actions /steps in the workflow. For example, only steps labeled with some label x may be run by user 102. Labels facilitate use of a single (e.g. parent) workflow to be applied to a plurality of events (e.g. children), which may have some unique characteristics that differ in some respects from other events (e.g. other children) also associated with the workflow. Labels may simplify administration and maintenance of workflows.

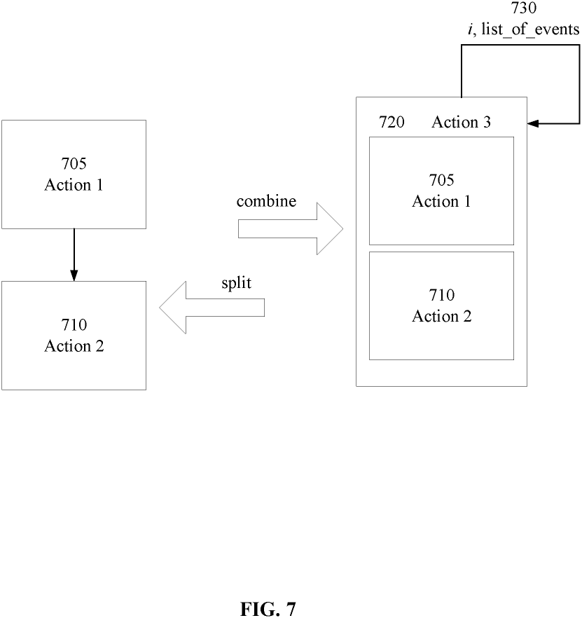

FIG. 7 illustrates some operations available to user to configure actions /steps associated with workflows. In some embodiments, the operations illustrated in FIG. 7 may be available to user 102 in UI 104. As shown in FIG. 7, two adjacent elemental steps Action 1 705 and Action 2 710 may be combined to form combined step Action 3 720. Further, an action such as Action 3 720, which may be a composite action made up of two or more elemental steps, may be split into its component steps (or into combinations of the component steps). Combining elemental steps can facilitate execution and may also facilitate application of conditions and/or other operations to the component steps in a single operation. For example, iterator 730 may be applied to combined action Action 3 720. Iteration operations may run actions on an action / elemental step until some condition is met (e.g. a counter, list, etc.). For example, the iterator may be configured to operate using parameters such as
List: list name // name of the list over which the iteration is being performed
Item: list entry // name of current variable to which the actions are applied,
where “list_name” is the name of the list being iterated and “list_entry” holds the variable to which actions are being applied. For example, as shown in FIG. 7, Action 3 720 may be applied to all events in the “list_of_events” (i.e. iterated over the list of events). Thus, combining actions prior to applying iterator 730, allows composite Action 3 720 to be applied all events in the list.

Thus, disclosed embodiments provide an interactive runtime environment to configure, modify, save, and run workflows. The runtime environment facilitates the dynamic (e.g. during runtime / execution) modification (e.g. addition of new actions, deletion of existing actions, modifications/edits of actions) of running workflows. Moreover, as outlined above, any added actions / steps have visibility into all the execution states, data, and other variables from previously executed steps.

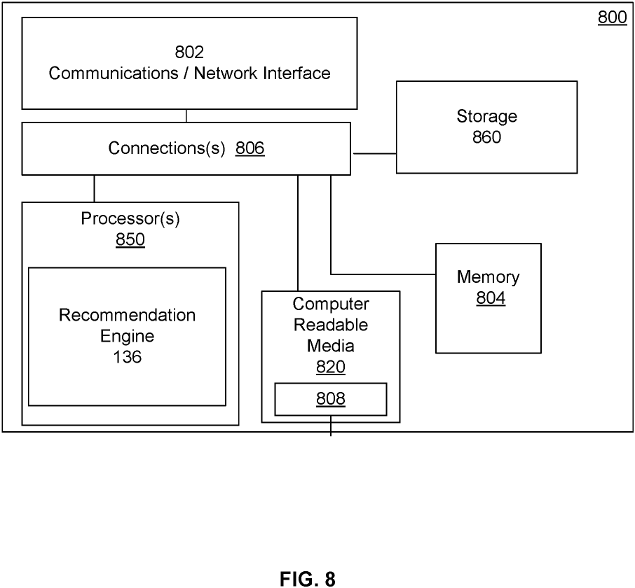

FIG. 8 shows an exemplary computer 800, which may be capable of implementing aspects of an automated incident response management system. For example, computer 800 may run execution environment 130-F and/or form the underlying hardware for private infrastructure 142 and/or public infrastructure 150. In some embodiments, IR team members may use example computer 800 to interact with execution environment 130-B on private infrastructure 142.

For example, computer 700 / processor(s) 750 may comprise one or more central processing units (CPUs), neural network processor(s) (NNPs), tensor processing units (TPUs), graphics processing units (GPUs) and/or distributed processors capable of being configured as a neural network, and/or be capable of executing software to facilitate machine learning and/or other AI applications. In some embodiments, computer 800 may be coupled to private infrastructure 142 and/or public infrastructure 150 using communications/network interface 802, which may include wired (e.g. Ethernet including Gigabit Ethernet) and wireless interfaces. Wireless interfaces may be based on: Wireless Wide Area Network (WWAN) standards such as cellular standards including 3G, 4G, and 5G standards; IEEE 802.11x standards popularly known as Wi-Fi. In some embodiments, communications /network interface may be used for integration with alert management systems. The terms “processor” or “processor(s)” may refer to a single processor, a processor with multiple cores, a multi-processing system, and/or distributed processors.

Computer 800 may include memory 804, which may include one or more of: Read Only Memory (ROM), Programmable Read Only Memory (PROM), Random Access Memory (RAM) of various types, Non-Volatile RAM, etc. Memory 704 may be implemented within processor(s) 850 or external to processor(s) 850. As used herein, the term “memory” refers to any type of long term, short term, volatile, nonvolatile, or other memory and is not to be limited to any particular type of memory or number of memories, or type of media upon which memory is stored.

Memory may comprise cache memory, primary memory, and secondary memory. Secondary memory may include computer-readable media 820. Computer-readable media drive 820 may include magnetic and/or optical media. Computer-readable media may include removable media 808. Removable media may comprise optical disks such as compact-discs (CDs), laser discs, digital video discs (DVDs), blu-ray discs, and other optical media and further include USB drives, flash drives, solid state drives, memory cards etc. Computer 800 may further include storage 860, which may include hard drives, solid state drives (SSDs), flash memory, and other non-volatile storage. Memory 804 and/or Computer-readable media drive 820, and/or removable media 808 may store AI/ML models, databases, program code, etc.

Communications / Network interface 802, storage 860, memory 804, and computer readable media 820 may be coupled to processor(s) 850 using connections 806, which may take the form of a buses, lines, fibers, links, etc.

The methodologies and functions described herein (e.g. in FIGS. 3, 4, 5, 6, and 7) may be implemented by various means depending upon the application. For example, these methodologies may be implemented in hardware, firmware, software, or any combination thereof. For a hardware implementation, the processor(s) 750 may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, or a combination thereof.

For a firmware and/or software implementation, the methodologies may be implemented with microcode, procedures, functions, and so on that perform the functions described herein. Any machine-readable medium tangibly embodying instructions may be used in implementing the methodologies described herein. For example, software may be stored in storage 860 and/or on removable computer-readable media 708. Program code may be resident on computer readable media 820, removable media 808, or memory 804 and may be read and executed by processor(s) 850.

If implemented in firmware and/or software, the functions may also be stored as one or more instructions or code computer-readable medium 820, removable media 808, and/or memory 804. Examples include computer-readable media encoded with data structures and computer programs. For example, computer-readable medium 820 and/or removable media 708 may include program code stored thereon may include program code to support methods for access control policy determination, management, provisioning, verification, and testing according to some disclosed embodiments. For example, computer-readable medium 820 and/or removable media 808 may include program code to support techniques disclosed in relation to FIGS. 2-7.

Processor(s) 850 may be implemented using a combination of hardware, firmware, and software. Processor(s) 850 may be capable of performing methods disclosed in in relation to FIGS. 2-7. In some embodiments, processor(s) 850 may include recommendation engine 136, which may include action-prediction model 246 and/or workflow prediction model 500. In some embodiments, computer 800 may be coupled to a display to facilitate viewing of GUIs and interaction with administrators and other users.

Although the present disclosure is described in connection with specific embodiments for instructional purposes, the disclosure is not limited thereto. Various adaptations and modifications may be made to the disclosure without departing from the scope. Therefore, the spirit and scope of the appended claims should not be limited to the foregoing description.

What is claimed is:

1. A processor-implemented method to facilitate automatic incident response, the method comprising:
receiving at least one event with an event descriptor, wherein the event descriptor includes an event identifier and an event description; and
predicting, based on at least one of the event identifier, or keyphrases in the event description, at least one of:
one or more actions in a workflow to respond to the event;
a workflow based on a corresponding input event descriptor; or
a combination thereof.

2. The method of claim 1, wherein the prediction of the one or more actions in the workflow is performed by an action-prediction model.

3. The method of claim 2, wherein the action-prediction model is obtained using machine learning techniques based on input keyphrase and action pairs.

4. The method of claim 1, wherein the prediction of the workflow is performed by a workflow-prediction model.

5. The method of claim 4, wherein the workflow-prediction model is obtained using machine learning techniques based on input workflows associated with prior events, wherein the prior events are associated with prior event descriptors.

6. The method of claim 1, wherein the one or more actions in the workflow to respond to the event are associated with one or more corresponding action risk-scores, and the workflow is associated with a corresponding workflow risk-score.

7. The method of claim 6, wherein the corresponding action risk score is based on one or more of: a corresponding action type, or a corresponding action environment, or a corresponding user profile associated with a user executing the action, or a combination thereof.

8. The method of claim 6, wherein the corresponding workflow risk score is based on one or more of: parameters associated with the one or more actions comprised in the workflow, or the one or more corresponding action risk scores of the one or more actions comprised in the workflow, or a combination thereof.

9. The method of claim 6, further comprising:
alerting a user when the corresponding one or more action risk scores exceeds an action risk threshold, or the corresponding workflow risk score exceeds a workflow risk threshold.

10. The method of claim 1, wherein the event is generated by one of agents running on a computing system, or an alert generation system, or a combination thereof.

11. The method of claim 1, wherein the at least one event comprises an operational request and the incident response occurs in response to the operational request.

12. A non-transitory computer-readable medium storing instructions, which when executed cause a processor to execute a method, the method comprising:
receiving at least one event with an event descriptor, wherein the event descriptor includes an event identifier and an event description; and
predicting, based on at least one of the event identifier, or keyphrases in the event description, at least one of:
one or more actions in a workflow to respond to the event;
a workflow based on a corresponding input event descriptor; or
a combination thereof.

13. The non-transitory computer-readable medium of claim 12, wherein the prediction of the one or more actions in the workflow is performed by an action-prediction model.

14. The non-transitory computer-readable medium of claim 13, wherein the action-prediction model is obtained using machine learning techniques based on input keyphrase and action pairs.

15. The non-transitory computer-readable medium of claim 12, wherein the one or more actions in the workflow to respond to the event are associated with one or more corresponding action risk-scores, and the workflow is associated with a corresponding workflow risk-score.

16. A processor-implemented method to facilitate automatic incident response, the method comprising:
determining based on one or more input sources associated with incident response events, one or more of one or more actions associated with at least one target environment and keyphrases associated with the actions;
training at least one of:
an action-prediction model using machine learning techniques based on input keyphrase and action pairs, wherein the action-prediction model is trained to predict an actions based on at least one corresponding input keyphrase; or
a workflow-prediction model using machine learning techniques based on input workflows and event descriptors, wherein the workflow-prediction model is trained to predict a workflow based on a corresponding input event descriptor; or
a combination thereof; and
deploying at least one of the action-prediction model, or the workflow-prediction model in an interactive incident response environment.

17. The method of claim 16, further comprising:
receiving an input event descriptor, the input event descriptor comprising an event identifier and one or more keyphrases describing the event; and
predicting, based on the input event descriptor, at least one of a workflow to respond to the event, or one or more actions in a workflow being composed to respond to the event.

18. The method of claim 16, wherein the input sources comprise one or more of: incident response audit trails, or
application programming interface (API) documentation for the at least one target environment, or
incident response runbooks, or
incident response text documentation, or
web based API sources, or
logged workflows, or
some combination thereof.

19. The method of claim 16, wherein natural language processing is applied to the input sources to determine keyphrases.

20. The method of claim 16, wherein the at least one event comprises an operational request and the incident response occurs in response to the operational request.
